(19) United States
(12) Patent Application Publication
(10) Pub. No.: US 2025/0214908 A1
(43) Pub. Date: Jul. 3, 2025

(54) CARRIER-BASED AGRICULTURAL BIOFERTILIZER COMPOSITION AND METHOD OF USING THE SAME

(71) Applicants: BENOY BERRY, LONDON (GB); PRAVEEN KUMAR DIVVELA, WEST GODAVARI (IN)

(72) Inventors: BENOY BERRY, LONDON (GB); PRAVEEN KUMAR DIVVELA, WEST GODAVARI (IN)

(21) Appl. No.: 19/087,630

(22) Filed: Mar. 24, 2025

(30) Foreign Application Priority Data
Mar. 25, 2024 (GB) GB2404248.3

(51) Int. Cl. C05F 11/08; A01C 21/00; C05F 17/20; C05G 5/27

(52) U.S. Cl. CPC C05F 11/08; C05F 17/20; C05G 5/27; A01C 21/00

(57) ABSTRACT

Exemplary embodiments of the present disclosure are directed towards a carrier-based agricultural biofertilizer composition, comprising an isolated Bacillus megaterium strain CGAPGPBBS-034 having the deposit accession number KY495205; and an agriculturally acceptable liquid formulation with a stabilizer to provide stability and support for at least one of the Bacillus species, thereby enhancing the growth and overall health of the plants.

### CROSS-REFERENCE TO RELATED APPLICATIONS

This patent application claims priority benefit of UK Patent Application No: GB2404248.3, entitled “A CARRIER-BASED AGRICULTURAL BIOFERTILIZER COMPOSITION AND METHOD OF USING THE SAME”, filed on 25 Mar. 2024. The entire contents of the patent application are hereby incorporated by reference herein in its entirety.

### TECHNICAL FIELD

The present disclosure generally relates to microbial biofertilizer compositions, more particularly the invention relates to a carrier-based agricultural biofertilizer composition and a method for enhancing soil using the biofertilizer composition.

### BACKGROUND

Agricultural biofertilizers have gained significant attention as sustainable alternatives to conventional chemical fertilizers. These biofertilizers consist of living microorganisms, such as bacteria, fungi, and algae, which contribute to nutrient cycling, soil health, and plant growth. Unlike synthetic fertilizers, biofertilizers offer numerous advantages, including environmental safety, improved soil fertility, and reduced reliance on non-renewable resources. Furthermore, they promote the use of organic waste materials as a valuable resource for agriculture. The growing demand for organic and sustainable farming practices has created a need for innovative biofertilizer compositions that can enhance nutrient availability and optimize crop productivity while minimizing the negative impacts on the environment.

Phosphate-solubilizing bacteria (PSB) are key components of biofertilizers, playing a vital role in improving nutrient availability. These beneficial microorganisms possess the ability to solubilize inorganic phosphorus, converting it into soluble forms that plants can readily absorb. By releasing organic acids and enzymes, PSB break down insoluble phosphate, making it accessible to plant roots. The application of PSB in biofertilizers offers several advantages: it reduces reliance on conventional phosphate fertilizers, thereby minimizing environmental impact; it promotes sustainable farming practices by improving nutrient use efficiency and reducing nutrient losses; and it enhances soil fertility by stimulating beneficial microbial activity and supporting nutrient cycling. Incorporating phosphate-solubilizing bacteria into biofertilizers is a promising approach to optimize nutrient availability, increase crop productivity, and foster overall agricultural sustainability.

Conventional phosphate fertilizers exert numerous detrimental effects on soil biology, including enhanced acidification, reduced microbial activity, nutrient imbalances, increased salinity, and environmental pollution. These fertilizers are typically acidic in nature, leading to a decrease in soil pH upon application. Such acidification adversely affects soil microorganisms, which play a vital role in nutrient cycling and soil health. The overuse or improper use of conventional phosphate fertilizers can further diminish microbial activity in the soil. Moreover, these fertilizers often contain high levels of phosphate while lacking other essential nutrients like nitrogen, potassium, and micronutrients. This nutrient imbalance disrupts the soil's nutrient profile, detrimentally impacting soil biology and vital functions. Excessive application of conventional phosphate fertilizers can also elevate soil salinity, which inhibits plant growth and diminishes microbial activity. Furthermore, when overused or misused, these fertilizers can leach into groundwater and surface water, causing pollution and posing a threat to aquatic ecosystems.

The microbial activity in alkaline soils is typically low, which hinders the ability of microorganisms, including phosphate-solubilizing bacteria (PSBs), to effectively solubilize phosphate. The alkaline conditions in these soils restrict microbial growth and activity, as microbial activity is directly influenced by soil pH. Furthermore, not all PSB strains are equally proficient at solubilizing phosphate in alkaline soils. Hence, the careful selection of effective PSB strains becomes crucial for successful phosphate solubilization in such environments. Additionally, PSB formulations can encounter viability challenges in the soil, including factors like low temperature, insufficient soil moisture, and competition with other microorganisms. These factors can limit the effectiveness of PSBs in solubilizing phosphate. Overcoming these challenges is vital to achieving successful phosphate solubilization in alkaline soils and enhancing agricultural productivity in these regions.

In the light of the aforementioned discussion, there exists a need for a certain system with novel methodologies that would overcome the above-mentioned disadvantages.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An embodiment of the present disclosure is directed towards to a carrier-based agricultural biofertilizer composition.

An embodiment of the present disclosure is directed towards the carrier-based agricultural biofertilizer composition includes an isolated Bacillus megaterium strain CGAPGPBBS-034 having the deposit accession number KY495205; and an agriculturally acceptable liquid stabilizer selected to provide stability and support for the Bacillus strain, thereby enhancing the growth and overall health of the plants

An embodiment of the present disclosure is directed towards developing the carrier-based agricultural biofertilizer composition that includes an isolated Bacillus megaterium strain (CGAPGPBBS-034) and an agriculturally acceptable liquid stabilizer, enabling enhanced plant growth and overall plant health.

An embodiment of the present disclosure directed towards the Bacillus megaterium strain CGAPGPBBS-034 that exhibits plant growth-promoting abilities through the production of phytohormones, including indoleacetic acid, as well as the secretion of siderophores and other secondary metabolites that provide protection against pathogenic organisms.

An embodiment of the present disclosure directed towards the Bacillus megaterium strain that may effectively altering soil texture to enhance plant growth and increase germination rates, while improving phosphorus uptake in higher pH environments.

An embodiment of the present disclosure directed towards selecting a liquid solution with a stabilizer allows the bacterial cells to stay stable in the soil for a long time, improving plant health.

An embodiment of the present disclosure is directed towards isolating Bacillus megaterium strain (CGAPGPBBS-034) from alkaline calcareous soil in the rhizosphere and rhizoplane from Yola, Nigeria, for use in the biofertilizer composition.

An embodiment of the present disclosure is directed towards isolating Bacillus megaterium strain (CGAPGPBBS-034) using a serial dilution technique and spread plate method, ensuring the purity and viability of the strain for effective biofertilizer formulation.

An objective of the present disclosure is directed towards enabling the capability of Bacillus megaterium strain (CGAPGPBBS-034) to solubilize phosphate in higher pH conditions.

An objective of the present disclosure is directed towards harnessing the plant growth-stimulating properties of Bacillus megaterium strain (CGAPGPBBS-034) by producing phytohormones, specifically indoleacetic acid, which regulates plant growth, improves root development, and enhances overall plant vigor.

An embodiment of the present disclosure is directed towards establishing a method for enhancing soil using a biofertilizer composition, involving the preparation of a nutrient medium, fermentation of Bacillus megaterium strain (CGAPGPBBS-034), formulation with adjuvants, and application to soil and plant to enhance its quality.

Furthermore, the objects and advantages of this invention will become apparent from the following description and the accompanying annexed drawings.

### BRIEF DESCRIPTION OF DRAWINGS

The invention is more fully appreciated in connection with the following details. Other objects and advantages of the present invention will become apparent to those skilled in the art upon reading the following detailed description of the preferred embodiments, in conjunction with the accompanying drawings, wherein like reference numerals have been used to designate like elements. However, for clear illustration, reference numeral of the same element in different figures might be omitted.

FIG. 1 is a flow diagram depicting a method for enhancing soil using a biofertilizer composition.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. While the invention has been described by way of examples and in terms of preferred embodiments, it is to be understood that the invention is not limited thereto. Hence the present invention may be applied in various modifications other than the embodiment. The main characters of the embodiment will be illustrated in clear and simple way. Besides, not all of the characters of the embodiment have shown in figures. The figures included herein are illustrated diagrammatically and not drawn to scale, as they are provided as qualitative illustration of the concept of the present invention.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

Phosphate, an essential macronutrient, plays crucial roles in various cellular functions as organic compounds like phytates, nucleic acids, and phospholipids (Alori et al., 2017). However, the challenge lies in solubilizing phosphate in alkaline soils, which possess pH levels above 7.5, resulting in limited phosphate availability for plants (Zheng et al., 2019). Solubilizing phosphate in alkaline soils is accompanied by several significant issues, including phosphate deficiency addressed in recent studies through approaches such as utilizing sewage manure, animal manure, compost, biochar, struvite, or even excess use of phosphate fertilizer (Sheil et al., 2016; Khiari et al., 2020; Vanden Nest et al., 2021).

In an exemplary embodiment, an isolated Bacillus megaterium strain CGAPGPBBS-034 may be derived from the alkaline calcareous soil found in a cowpea farming field located in Yola, Nigeria. This strain may have been incorporated into a biofertilizer formulation designed to significantly enhance phosphate availability in soils with higher pH levels. The chosen strain demonstrates its efficacy in enhancing plant growth and promoting overall plant health by effectively solubilizing phosphate, specifically benefiting crops such as Cowpea (Vigna unguiculata), Groundnut (Arachis hypogaea), and Soybean (Glycine max) during both rainy and dry seasons.

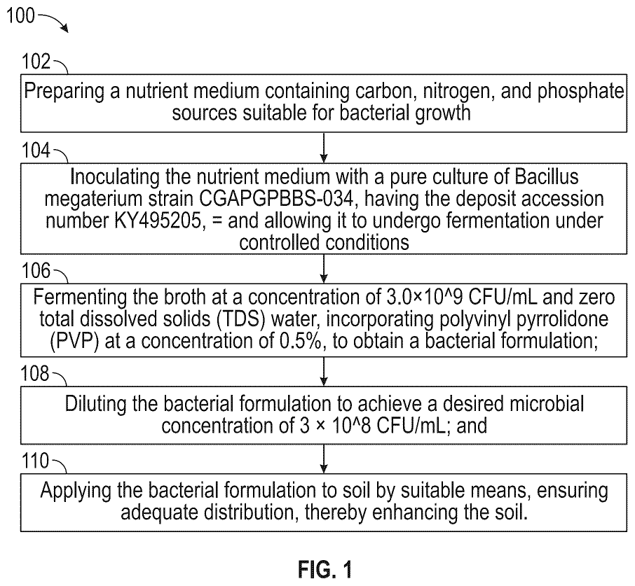

Referring to FIG. 1, 100 is a flow diagram depicting a method for enhancing soil using a biofertilizer composition. The method starts at step 102, preparing a nutrient medium containing carbon, nitrogen, and phosphate sources suitable for bacterial growth. At step 104, inoculating the nutrient medium with a pure culture of Bacillus megaterium strain CGAPGPBBS-034, having the deposit accession number KY495205, and allow it to undergo fermentation under controlled conditions. Fermenting the broth at a concentration of 3.0×10\hat{ }9 CFU/mL and zero total dissolved solids (TDS) water, incorporating polyvinyl pyrrolidone (PVP) at a concentration of 0.5%, to obtain a bacterial formulation at step 106. Diluting the bacterial formulation to achieve a desired microbial concentration of 3×10\hat{ }8 CFU/mL at step 108. At step 110, applying the bacterial formulation to soil by suitable means, ensuring adequate distribution, thereby enhancing the soil.

Morphological Characteristics of the Bacillus megaterium strain CGAPGPBBS-034:
Cell shape: Spherical colonies,
Cell size: 2 3 mm
Cell arrangement: rod arrangement
Gram stain: Positive
Motility: Yes
Pigment: Absent
Capsule: Absent
Spores: Endospore formation

Physiological Properties of the Bacillus megaterium strain CGAPGPBBS-034:
Behaviour to oxygen: Aerobic or facultative anaerobic
Conditions for growth: pH-6.6-8.5
Temperature −30±2° C.

Amplification and 16S rRNA Gene Sequence Analysis: After amplifying the partial 16S rRNA gene, cycle sequencing was performed through MACROGEN in Korea. The resulting amplified product underwent sequencing using the forward sequencing reaction mix. To determine homology, the DNA sequence was searched using the BLAST search engine at the NCBI site (ncbi.nlm.nih.gov) and FASTA (ebi.ac.uk). The FASTA homology search revealed similarity to Bacillus megaterium, and the corresponding strain obtained from NCBI was designated as KY495205.

In another exemplary embodiment, specific strains of advantageous bacteria may not naturally occur in a given field soil or, if present, may exist in limited numbers or exhibit reduced activity, thereby failing to impart any beneficial effects on plants in an unaltered or unenhanced rhizosphere. This is true regardless of the inherent valuable traits possessed by these bacteria.

In order for a bacterial strain with inherent beneficial traits, such as a plant growth-promoting rhizobacteria (PGPR), to exert a positive impact on plant growth, it must possess a competitive advantage and be a robust colonizer within the rhizosphere during active plant growth. It should be noted that without modifications or enhancements, it may highly improbable for any native or naturally occurring PGPR, including the bacterial strain CGAPGPBBS-034, to confer benefits to plant growth. This highlights the importance of creating conditions that favor the colonization and effectiveness of PGPR strains.

In another exemplary embodiment, the PGPR strain CGAPGPBBS-034 may has been obtained from the rhizosphere and may show a beneficial trait of solubilizing phosphorus in higher pH conditions, enhancing plant growth. Furthermore, laboratory cultivation techniques may have been utilized to optimize the growth and population density of CGAPGPBBS-034, thereby maximizing its PGPR properties. These specific growth conditions may have been identified to enhance the competitive advantage of CGAPGPBBS-034 when applied to the rhizosphere, resulting in a positive impact on plant growth. In essence, the determination of growth conditions that promote the successful colonization of the rhizosphere by CGAPGPBBS-034 has enabled its beneficial effects on plant growth, which would not be achievable under normal circumstances.

In another exemplary embodiment, a biologically pure culture of CGAPGPBBS-034 may be grown to prepare a stock culture. Aliquots of this stock culture were preserved in cryogenic vials in a −80° C. For production runs, frozen stock culture may be used to inoculate a flask containing nutrient broth media and under specific conditions.

In another exemplary embodiment, the bacterial culture may be cultivated at a temperature range of 30-32° C. during the rainy season, and in alternative embodiments, at a temperature range of 48-50° C. during the dry season. The flask culture is then scaled up in a fermenter under similar growth conditions, resulting in increased population growth and enhanced plant growth-promoting properties of CGAPGPBBS-034 as the culture reaches the early stationary phase. Aliquots from the early stationary phase culture are aseptically packaged in sterilized plastic bags. The final product has a minimum concentration of the active ingredient, with a viability of at least 3×10⁸ colony forming units per mL. The fermented culture of strain CGAPGPBBS-034 is grown under optimized conditions to ensure maximum bacterial viability and retention of plant growth-promoting properties. The liquid formulation stored in sterile bags can be preserved for viable count analysis. Notably, when the liquid formulation is subjected to different temperatures, CGAPGPBBS-034 exhibits a response to temperature variation. Shelf-life studies demonstrate that even after 18 months of storage at both temperatures, the minimum count of bacterial cells remains at 2×10⁸, indicating the sustained viability of the strain.

In another exemplary embodiment, the phytotoxic effects of Bacillus megaterium CGAPGPBBS-034 may assess during a field experiment by monitoring symptoms such as tip injury, wilting, vein clearing, necrosis, and epinasty/hyponasty. Interestingly, no symptoms were observed during or after the application of Bacillus megaterium CGAPGPBBS-034 to all three crops in both seasons. These findings may demonstrate the absence of any harmful effects on the plants, indicating that CGAPGPBBS-034 is an effective plant growth-promoting bacterium suitable for commercial use in both normal and higher pH conditions. Furthermore, it may be utilized in different temperature conditions within Nigeria.

In another exemplary embodiment of the present disclosure, Bacillus megaterium strain CGAPGPBBS-034 may be isolated from the alkaline calcareous soil of rhizosphere and rhizoplane from Yola, Nigeria.

In another exemplary embodiment of the present disclosure, wherein Bacillus megaterium strain CGAPGPBBS-034 may be isolated by serial dilution technique and spread plate method.

In another exemplary embodiment of the present disclosure, Bacillus megaterium strain CGAPGPBBS-034 may be capable of phosphate solubilization in higher pH conditions, thereby enabling the availability of phosphorus to plants even in alkaline or high pH soil environments.

In another exemplary embodiment of the present disclosure, Bacillus megaterium strain CGAPGPBBS-034 may has the ability to stimulate plant growth through the production of phytohormones, including indoleacetic acid, thereby regulating plant growth, improving root development, and enhancing overall plant vigor.

In another exemplary embodiment of the present disclosure, the nutrient medium of the method 100 may comprise carbon sources selected from the group consisting of sucrose, glucose, and molasses, nitrogen sources selected from the group consisting of ammonium sulfate, urea, and peptone, and phosphate sources selected from the group consisting of calcium phosphate, potassium phosphate, and sodium phosphate, providing optimal conditions for bacterial growth and nutrient assimilation.

In another exemplary embodiment of the present disclosure, the fermentation may becarried out under controlled conditions including temperature, pH, and oxygen levels, to promote optimal bacterial growth and metabolic activity.

In another exemplary embodiment of the present disclosure, wherein the application of the bacterial formulation to soil is performed using sprinkler irrigation, spray application, drone-based application, soil mixing techniques, seed deepening methods, plant root deepening methods, or any combination thereof.

In another exemplary embodiment of the present disclosure, wherein the bacterial formulation is mixed with a carrier material selected to provide stability to the bacterial cells in the soil for an extended period, thereby enhancing plant health and promoting long-term effectiveness of the biofertilizer.

Example: 1—Isolation of rhizobacteria: Bacteria were isolated from the alkaline calcareous soil of rhizosphere and rhizoplane from Yola, Nigeria by a serial dilution technique and spread plate method.

Process for isolation and cultivation of Bacteria from Soil Sample:
a) Obtain a sample containing bacteria, either by scraping the soil surface or using a sterile instrument to collect a soil core.
b) Prepare nutrient agar plates by sterilizing them through autoclaving and allowing them to cool to room temperature. These plates will serve the purpose of isolating bacteria from the soil sample.
c) Take a small portion of the soil sample and evenly distribute it across the surface of the nutrient agar plate. Incubate the plates at temperatures ranging from 30-37° C. for a period of 24-48 hours.
d) After the incubation period, bacterial growth should be visible on the nutrient agar plates. Select one or more colonies and streak them onto new nutrient agar plates to obtain pure cultures.
e) Store the pure cultures in 50% glycerol solution for future utilization.

### Example: 2—Phosphate Solubilization Test: Phosphate Solubilization Assay Steps of Bacterial Strain CGAPGPBBS-034

i. Prepare nutrient agar plates and streak the bacterial strain CGAPGPBBS-034 to obtain a fresh culture. Incubate the plates at the appropriate temperature for 24-48 hours until visible colonies form.
ii. Inoculate a single colony of the bacterial strain CGAPGPBBS-034 into a 5 mL nutrient broth and incubate at the appropriate temperature with shaking for 24 hours.
iii. For phosphate solubilization assay, inoculate pure bacterial colonies onto agar plates medium known as National Botanical Research Institute Phosphorus (NBRIP) medium. The NBRIP medium contains 10 g glucose, 5 g MgCl₂·6H₂O, 0.25 g MgSO₄·7H₂O, 0.2 g KCl, 0.1 g (NH₄)₂SO₄, and 15 g Agar in 1 L distilled water, supplemented with 5 g tricalcium phosphate (TCP) as the sole source of phosphorus.
iv. Incubate the plates for 6-7 days at 30° C. Record the presence of a halo zone around the bacterial colonies.
V. Calculate the solubilization index, which is the ratio of the total diameter (colony+halo zone) to the colony diameter, using the following formula.
vi. The results of the phosphate solubilization index for the bacterial strain CGAPGPBBS-034 on NBRIP media were found to be approximately 2.4.

### Example: 3—Phosphate Solubilization Activity in a Higher pH Medium

a. Prepare nutrient agar plates and streak the bacterial strain CGAPGPBBS-034 for fresh culture. Incubate the plates at the appropriate temperature for 24-48 hours until visible colonies form.
b. Inoculate a single colony of the bacterial strain CGAPGPBBS-034 into a 5 mL nutrient broth and incubate at the appropriate temperature with shaking for 24 hours.
c. Prepare a higher pH medium using Tris-HCl buffer in NBRIP broth to adjust the pH up to 8.5.
d. The bacterial isolate (0.3 ml inoculum with approximately 108 CFU ml-1) was inoculated into a test tube containing 10 mL of the higher pH medium. Incubate the test tube at the appropriate temperature with shaking.
e. Take 1 mL samples of the bacterial culture at different time intervals (e.g., every 24 hours) and transfer them to a fresh test tube.
f. Centrifuge the bacterial culture at 10,000×g for 5 minutes to pellet the cells.
g. Add 500 μL of the supernatant to 500 μL of a 0.5% ammonium molybdate solution in a new test tube. Mix well. Add 500 μL of 10% ascorbic acid solution into the test tube.
h. Incubate the test tube at room temperature for 10 minutes to allow for the color to develop.
i. Measure the absorbance of the solution at 660 nm using a spectrophotometer.
j. Calculate the phosphate solubilization activity by determining the difference in absorbance between the test sample and a control sample (nutrient broth without the bacterial culture).
k. Plot the phosphate solubilization activity and pH over time to determine the bacterial effect on pH of the medium.

1. Results illustrated that strain CGAPGPBBS-034 solubilized the phosphate in a higher pH medium than the control strain (Table 1).

TABLE 1
Phosphate solubilization activity in a higher pH medium

| CGAPGPBBS-034 | | | Control (E. coli) | | |
|---|---|---|---|---|---|
| Optical | | | Optical | | |
| Density | Soluble P | Growth | Density | Soluble P | Growth |
| (660 nm) | (mg L⁻¹) | medium pH | (660 nm) | (mg L⁻¹) | medium pH |
| 1.52 ± 0.02ef | 60.38 ± 0.70f | 8.15 ± 0.10a | 0.50 ± 0.01e | 8.05 ± 0.09f | 8.50 ± 0.00a |
| 1.66 ± 0.02d | 63.39 ± 0.74f | 7.65 ± 0.09b | 0.60 ± 0.01d | 10.06 ± 0.12e | 8.43 ± 0.06a |
| 1.81 ± 0.02bc | 68.43 ± 0.80f | 7.25 ± 0.08b | 1.01 ± 0.01a | 13.08 ± 0.15d | 8.35 ± 0.10ab |
| 1.96 ± 0.11a | 77.43 ± 4.27e | 6.30 ± 0.35c | 0.90 ± 0.05b | 14.45 ± 0.80d | 8.15 ± 0.26b |
| 1.93 ± 0.11ab | 85.68 ± 4.72d | 5.68 ± 0.31d | 0.77 ± 0.04c | 16.52 ± 0.91c | 7.68 ± 0.20c |
| 1.84 ± 0.10abc | 92.91 ± 5.12d | 5.26 ± 0.29def | 0.49 ± 0.03ef | 20.65 ± 1.14b | 7.51 ± 0.15cd |
| 1.72 ± 0.09cd | 105.30 ± 5.80c | 5.37 ± 0.30de | 0.47 ± 0.03efg | 24.78 ± 1.36a | 7.51 ± 0.15cd |
| 1.61 ± 0.09de | 117.69 ± 6.48b | 4.96 ± 0.27ef | 0.47 ± 0.03efg | 25.81 ± 1.42a | 7.51 ± 0.15cd |
| 1.50 ± 0.08ef | 129.71 ± 6.60a | 4.85 ± 0.27f | 0.45 ± 0.03fg | 25.81 ± 1.42a | 7.41 ± 0.15d |
| 1.47 ± 0.08f | 132.81 ± 6.77a | 4.85 ± 0.27f | 0.43 ± 0.02g | 25.81 ± 1.42a | 7.31 ± 0.16d |

Columns marked with the same alphabetical letter(s) within comparable means (n = 3) in the same column do not differ significantly using the revised least significant difference (LSD) test at p = 0.05 levels;
E. coli = Escherichia coli;
Mean ± standard deviation

### Example: 4—Inoculation Effect on Cowpea, Groundnut, and Soybean Seed Emergence

a) Bacterial strain SVRGM/DBT2/03/2020 was grown in 100 ml of Nutrient broth for 48 hours on a rotary shaker. Bacterial cell culture was concentrated by centrifugation and washed with distilled water and suspended in NaCl solution.
b) Take the surface sterilized legume seeds and place the legume seeds in a petri dish lined with a damp paper towel. Ensure that the seeds are spread out evenly and not touching each other.
c) Add the appropriate amount of inoculant to the seeds in the petri dish. Mix the seeds and inoculant gently to ensure that the seeds are evenly coated.
d) Seal the petri dish with parafilm to maintain moisture and prevent contamination.
e) Place the petri dish in a warm location (30° C.) for 24-48 hours to allow for the inoculant to adhere to the seeds.
f) After the incubation period, plant the inoculated seeds in sterile soil with 3 cm planting depth and spacing for the specific legume species.
g) Water the seeds immediately after planting and ensure that the soil remains moist throughout the germination period.
h) Record the number of seedlings that emerge from the inoculated seeds and compare it to the number of seedlings that emerge from non-inoculated seeds.
i) Calculate the percentage of seedling emergence for both the inoculated and non-inoculated seeds.
j) Analyze the data to determine the effect of inoculation on seedling emergence.
k) Results illustrated that cowpea, groundnut, and soybean seeds inoculated with strain SVRGM/DBT2/03/2020 enhanced seed emergence by 30 to 35% compared to the control.

### Example: 5-Effect of PGPR Inoculation on Cowpea, Groundnut, and Soybean Yield in Field Trials During Rainy and Dry Season

i. The trial was conducted in 2016 rainy season from July to December 2016 and in 2017 dry season from January to June 2017 at two different locations using strain CGAPGPBBS-034 with three crops cowpea, groundnut, and soybean.
ii. The field trials were planted through a commercial seed planter and foliar bacterial treatment was applied using 2 liters handheld sprayer in the volume of 250-300 liters per hectare.
iii. All field trials were conducted in the randomized complete block design (RCBD), each crop trials were size of 10 acres, with bacterial treatment along with two kinds of control (chemical fertilizer control and untreated control), replicated three times. The treatments were designed to evaluate the bacterial ability to enhance crop yield.
iv. Crops were harvested at maturity, seed was collected and cleaned, and yield was measured.
v. Results illustrated that cowpea, groundnut, and soybean yield significantly enhanced as compared to controls (Table 2).

TABLE 2
Result of example 5 Effect of PGPR Inoculation on cowpea, groundnut,
and soybean Yield in Field Trials during the rainy and dry season

| | Location 1 | | | Location 2 | | |
|---|---|---|---|---|---|---|
| Treatments | Cowpea | Groundnut | Soybean | Cowpea | Groundnut | Soybean |

Rainy season

| | | | | | | |
|---|---|---|---|---|---|---|
| CGAPGPB | 1525.57 ± | 1944.55 ± | 1685.44 ± | 1287.17 ± | 1922.11 ± | 1878.69 ± |
| BS-034 | 70.07a | 85.95a | 85.97a | 56.89a | 78.42a | 81.18a |
| Chemical | 1369.18 ± | 912.93 ± | 1399.53 ± | 1084.70 ± | 1585.98 ± | 1712.80 ± |
| control | 62.89b | 40.35b | 71.38b | 47.94b | 64.71b | 74.01b |
| Untreated | 846.36 ± | 658.45 ± | 1289.06 ± | 955.68 ± | 1383.97 ± | 1178.09 ± |
| control | 38.87c | 29.10c | 65.75b | 42.24c | 56.47c | 50.91c |

Dry season

| | | | | | | |
|---|---|---|---|---|---|---|
| CGAPGPB | 2388.60 ± | 1821.00 ± | 2681.45 ± | 2364.74 ± | 1782.02 ± | 2295.40 ± |
| BS-034 | 108.49a | 104.48a | 122.60a | 109.19a | 80.11a | 111.62a |
| Chemical | 2163.68 ± | 1593.35 ± | 1947.63 ± | 1964.93 ± | 1547.64 ± | 1929.60 ± |
| control | 98.27b | 91.42b | 89.05b | 90.73b | 69.57b | 93.83b |
| Untreated | 2004.92 ± | 1501.45 ± | 1748.41 ± | 1656.29 ± | 1288.26 ± | 1596.66 ± |
| control | 91.06b | 86.14b | 79.94c | 76.48c | 57.91c | 77.64c |

Columns marked with the same alphabetical letter(s) within comparable means (n = 3) in the same column do not differ significantly using the revised least significant difference (LSD) test at p = 0.05 levels; Mean ± standard deviation

### Example: 6—Identification Process of Rhizobacterial Strain

a) The bacterial strain CGAPGPBBS-034 was grown on nutrient agar media for 24 hours. Then the bacterial DNA was extracted.
b) The partial 16S rRNA gene was amplified, then subjected to cycle sequencing through MACROGEN, Korea.
c) The amplified product was sequenced using the forward sequencing reaction mix. The DNA sequence was searched for homology using BLAST search engine at NCBI site (ncbi.nlm.nih.gov) and FASTA (ebi.ac.uk).
d) In the FASTA homology search showed similarity towards the Bacillus megaterium, and the strain obtained from NCBI was designated as KY495205.

Example: 7—Commercial Exploitation (viability and phytotoxicity): The Bacillus megaterium strain CGAPGPBBS-034 may demonstrates the ability to solubilize phosphate in alkaline soils and positively influence the germination and yield of diverse crop varieties. Although some rhizospheric microbes may possess advantageous traits for other crops, the presence of specific bacterial populations in the rhizosphere, without modification or supplementation, is primarily may be determined by the availability of substrates, prevailing environmental conditions (such as soil moisture, pH, and organic matter content), and the competition among different microbial communities. These beneficial microbes may establish colonization on plant roots, enhancing nutrient absorption, synthesizing growth hormones, and providing protection against diseases, thereby promoting overall plant growth and health.

We claim:

1. A carrier-based agricultural biofertilizer composition, comprising:
an isolated Bacillus megaterium strain CGAPGPBBS-034 having the deposit accession number KY495205; and
an agriculturally acceptable liquid formulation with a stabilizer to provide stability and support for at least one of the Bacillus species, thereby enhancing the growth and overall health of the plants.

2. The composition as claimed in claim 1, wherein Bacillus megaterium strain CGAPGPBBS-034 was isolated from the alkaline calcareous soil of rhizosphere and rhizoplane from Yola, Nigeria.

3. The composition as claimed in claim 1, wherein Bacillus megaterium strain CGAPGPBBS-034 was isolated by a serial dilution technique and spread plate method.

4. The composition as claimed in claim 1, Bacillus megaterium strain CGAPGPBBS-034 is capable of phosphate solubilization in higher pH conditions, thereby enabling the availability of phosphorus to plants even in alkaline or high pH soil environments.

5. The composition as claimed in claim 1, Bacillus megaterium strain CGAPGPBBS-034 has the ability to stimulate plant growth through the production of phytohormones, including indoleacetic acid, thereby regulating plant growth, improving root development, and enhancing overall plant vigor.

6. A method for enhancing soil using a biofertilizer composition, comprising the steps of:
preparing a nutrient medium containing carbon, nitrogen, and phosphate sources suitable for bacterial growth;
inoculating the nutrient medium with a pure culture of Bacillus megaterium strain CGAPGPBBS-034, having the deposit accession number KY495205, and allowing it to undergo fermentation under controlled conditions;
harvesting the bacterial cells from the fermented broth using appropriate separation techniques;
fermenting the broth at a concentration of 3.0×10\hat{ }9 CFU/mL and zero total dissolved solids (TDS) water, incorporating polyvinyl pyrrolidone (PVP) at a concentration of 0.5%, to obtain a bacterial formulation;
diluting the bacterial formulation to achieve a desired microbial concentration of 3×10\hat{ }8 CFU/mL; and
applying the bacterial formulation to soil by suitable means, ensuring adequate distribution, thereby enhancing the soil.

7. The method as claimed in claim 6, wherein the nutrient medium comprises carbon sources selected from the group consisting of sucrose, glucose, and molasses, nitrogen sources selected from the group consisting of ammonium sulfate, urea, and peptone, and phosphate sources selected from the group consisting of calcium phosphate, potassium phosphate, and sodium phosphate, providing optimal conditions for bacterial growth and nutrient assimilation.

8. The method as claimed in claim 6, wherein the fermentation is carried out under controlled conditions including temperature, pH, and oxygen levels, to promote optimal bacterial growth and metabolic activity.

9. The method as claimed in claim 6, wherein the application of the bacterial formulation to soil is performed using sprinkler irrigation, spray application, drone-based application, soil mixing techniques, seed deepening methods, plant root deepening methods, or any combination thereof.

10. The method as claimed in claim 6, wherein the bacterial formulation is mixed with a carrier material selected to provide stability to the bacterial cells in the soil for an extended period, thereby enhancing plant health and promoting long-term effectiveness of the biofertilizer.
